(19) United States
(12) Patent Application Publication
(10) Pub. No.: US 2003/0225989 A1
(43) Pub. Date: Dec. 4, 2003

(54) System for calculating billable time

(76) Inventor: Susan L. Licalsi, Montclair, NJ (US)

Correspondence Address: CASELLA & HESPOS, 274 MADISON AVENUE, NEW YORK, NY, 10016

(21) Appl. No.: 10/439,179

(22) Filed: May 15, 2003

Related U.S. Application Data
(60) Provisional application No. 60/381,828, filed on May 16, 2002.

(51) Int. Cl. G06F 12/00

(52) U.S. Cl. 711/167

(57) ABSTRACT

A method and system for tracking time spent working on each file in a set of computer files is provided. The method includes the steps of detecting an opening of at least one file; recording a start time of the opening of the at least one file; monitoring the at least one opened file for user activity; if no user activity is detected, recording a stop time for the at least one opened file; and determining the time spent working on the at least one file from the start time and stop time. The method is further adapted for detecting openings of a plurality of files; recording a start time of a first file wherein activity is detected; and upon detecting activity in a second file, recording a stop time for the first file and recording a start time for the second file.

This application claims priority on U.S. Provisional Patent Appl. No. 60/381,828, filed May 16, 2002.

### BACKGROUND OF THE INVENTION

1. Field of the Invention

The present invention relates to time keeping for services performed and particularly to a method and means for professional people and other workers performing services on a computer to automatically track the amount of time spent on different matters for billing purposes.

2. Description of the Related Art

Various systems are available for timing activities and for the tracking of the time passing during endeavors involving billing for time spent. For example, there are automatic timing features presently used on telephones to clock the duration of calls so that the phone charges may be determined for billing purposes. Also, U.S. Pat. No. 4,796,131 to WIEDEMER discloses a system for timing the use of licensed software on a computer to record the usage of a particular program for billing purposes. This system is provided with a security feature to prevent a user from tampering with the timing to avoid deliberate alteration of the time record since the recorded time is the source of billing for the software licensor.

These noted prior art systems for tracking the use of telephones and computer software operate generally in the automatic mode and offer limited control to the user for starting and ending the timing during the period that the system devices are operating. Hence, these and the other known prior art systems for time tracking are not suitable for use by professional people or workers performing services on a computer to track the amount of time spent on different matters for billing purposes as they are not amenable to being started and stopped by the user or automatically so as to appropriately control the counting and facilitate the ordering of time charges and bills. Furthermore, these known systems do not account for gaps in billable time on the computer because the user has been diverted to nonbillable time or to matters that must be billed to a different matter.

### SUMMARY OF THE INVENTION

The present invention involves a timeclock program, in software or hardware or both, which may be used by someone performing services on a computer or like device to track the time spent working within a file so that the user has a record of and knows exactly how much service time was spent working on a matter in a specific file for cost purposes. In accordance with an embodiment of the present invention a database is provided into which the filenames of the various computer files to be timed may be keyed or otherwise listed. When a tracking timeclock is activated, either by the user or automatically, the computer file that is open for work will have its filename checked with the database list for recognition and the time spent in the file is recorded in connection with the appropriate filename. The set of filenames contained in the filename database enables the user to jump from one file to another while working, as the program can be adapted to recognize which file is open and being worked in and to associate the respective time spent with the appropriate file for separately recording the time applied in each file. The timeclock will pause after a selected time period of inactivity on a file even though a file may still be open. The timeclock will continue when activity on the file resumes. Thus, no billing time will be generated while the user is diverted from active work on a file by a telephone call, a conference, a coffee break or the like even though the file may remain open. The various times that are recorded by the program in association with each file can be accessed and read out on the computer display screen or on a printable report in itemized form when preparing a time charge bill for a client.

According to an aspect of the present invention, a method for tracking time spent working on each file in a set of computer files is provided. The method comprising the steps of detecting an opening of at least one file; recording a start time of the opening of the at least one file; monitoring the at least one opened file for user activity; if no user activity is detected, recording a stop time for the at least one opened file; and determining the time spent working on the at least one file from the start time and stop time.

In another aspect of the present invention, the method further comprises the steps of detecting openings of a plurality of files; recording a start time of a first file wherein activity is detected; and upon detecting activity in a second file, recording a stop time for the first file and recording a start time for the second file.

In a further aspect of the present invention, a program storage device readable by a machine, tangibly embodying a program of instructions executable by the machine to perform method steps for tracking time spent working on each file in a set of computer files is provided, the method steps comprising detecting an opening of at least one file; recording a start time of the opening of the at least one file; monitoring the at least one opened file for user activity; if no user activity is detected, recording a stop time for the at least one opened file; and determining the time spent working on the at least one file from the start time and stop time.

According to a further aspect of the present invention, a system for tracking time spent working on each file in a set of computer files is provided. The system comprising means for detecting an opening of at least one file; means for recording a start time of the opening of the at least one file; means for monitoring the at least one opened file for user activity; if no user activity is detected, recording a stop time for the at least one opened file; and means for determining the time spent working on the at least one file from the start time and stop time.

### BRIEF DESCRIPTION OF THE DRAWINGS

The above and other aspects, features and advantages of the present invention will become more apparent in light of the following detailed description when taken in conjunction with the accompanying drawings in which:

FIG. 1 is a block diagram of an exemplary system for calculating billable time according to an embodiment of the present invention.

FIG. 2 is a schematic diagram of a flowchart to depict operation of the system and method of the present invention.

FIGS. 3A-3E are exemplary screen shots of project/client list (FIG. 3A), client data (FIG. 3B), object or file data (FIG. 3C), options data (FIG. 3D) and activity data (FIG. 3E) according to an embodiment of the present invention.

FIG. 4 is a flowchart illustrating a method for calculating billable time of computer files worked on according to an embodiment of the present invention.

### DETAILED DESCRIPTION OF PREFERRED EMBODIMENTS

Preferred embodiments of the present invention will be described hereinbelow with reference to the accompanying drawings. In the following description, well-known functions or constructions are not described in detail to avoid obscuring the invention in unnecessary detail.

A timeclock program, implemented in software or hardware or both, is provided to be used by persons performing services on a computer or like device to track the time spent working within a particular file so that the program user has a record of and knows exactly how much service time was spent working on a matter in the particular file for cost purposes. The program may have particular applicability to graphic artists, editors, attorneys, accountants or other service-related professionals who bill customers, clients or employers based on a per hour charge for time spent on a particular job.

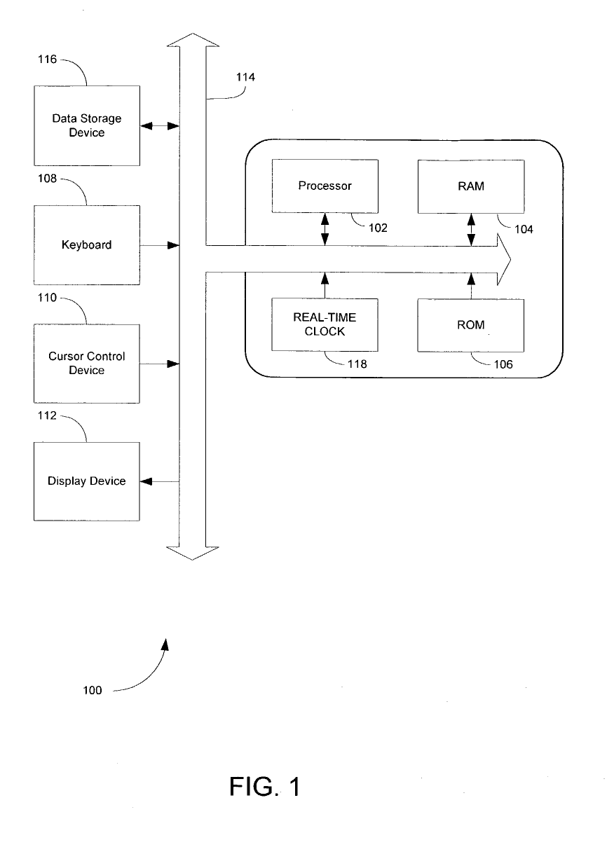

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture such as that shown in FIG. 1. Preferably, the machine 100 is implemented on a computer platform having hardware such as one or more central processing units (CPU) 102, a random access memory (RAM) 104, a read only memory (ROM) 106 and input/output (I/O) interface(s) such as keyboard 108, cursor control device (e.g., a mouse) 110 and display device 112. The various hardware components are coupled together via bus 114 or other communication means for communicating information. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device 116 and a printing device. Furthermore, a real-time clock 118 is coupled to the machine 100 for sending the correct date and time to an internal clock of the operating system.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

The timeclock program will be a combination of a system background service and a graphical user interface that will facilitate the time keeping on a particular project based on application and file use. It is to be understood that an application program, e.g., Microsoft Word, Adobe Illustrator, Adobe Photoshop, is software that generates or modifies a file. Furthermore, the timeclock program may be adapted to function in any known or future operating system, for example, Windows, Macintosh, Unix, etc.

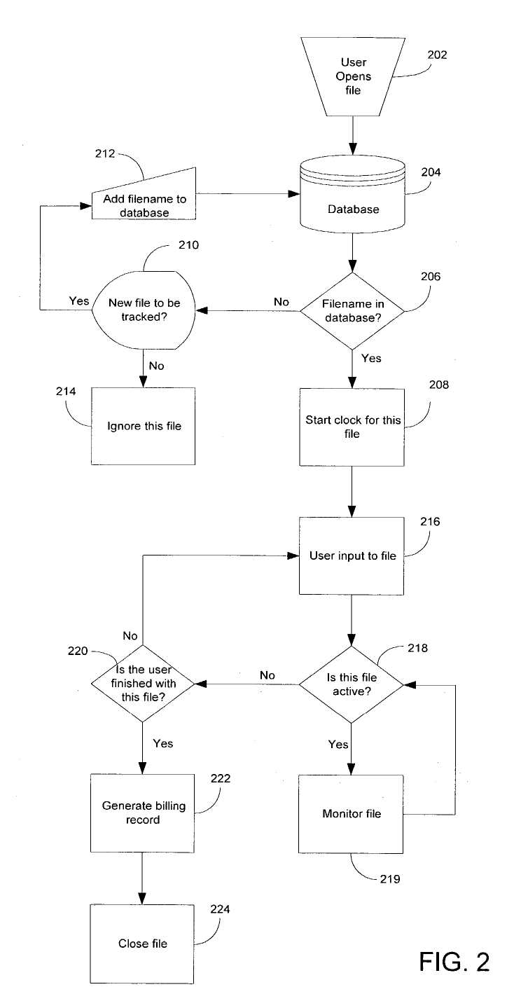

FIG. 2 is a schematic diagram of a flowchart to depict operation of the system and method of the present invention.

Operation of the timeclock program may be initiated automatically when the computer is booted up by a command item in the startup program, or the user may start the program manually at any time before or after entering a file to be worked on. Once the timeclock program is open and operating, a filename of the file to be entered and worked on is input to and recognized by the program. Preferably, the inputting and recognizing of the filename is performed by simply opening the file to be worked on (Step 202), as will be described below.

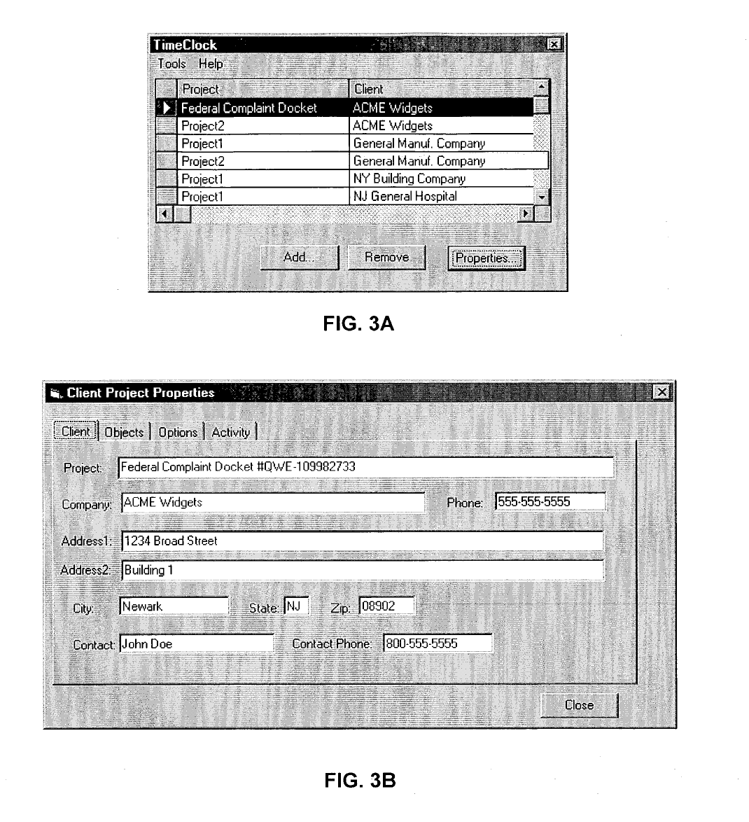

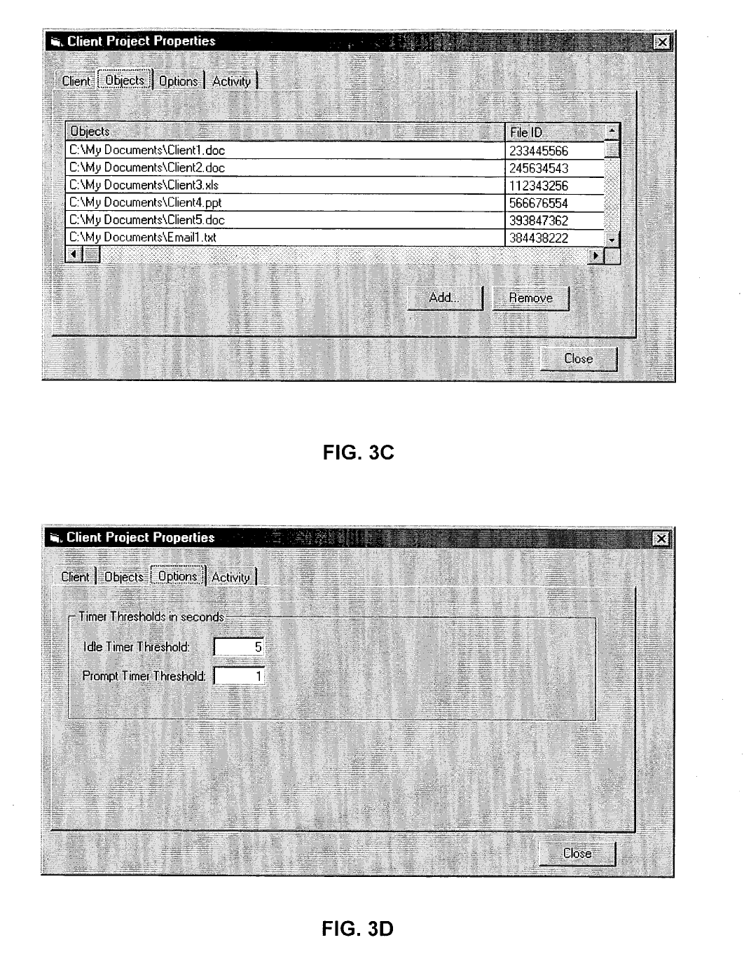

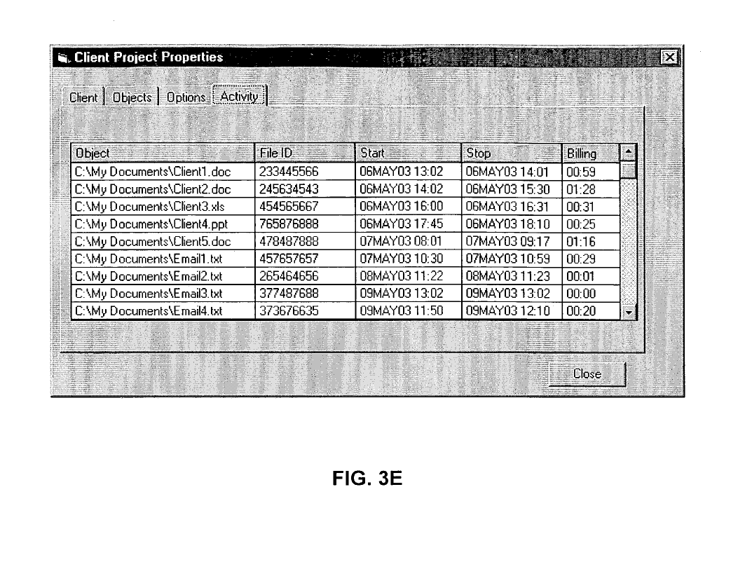

The program contains a database 204 into which the filenames of the various files to be timed may be keyed or otherwise listed. The database will be a file-based relational database via ODBC (Open Database Connectivity), e.g., Microsoft Access. The database may be organized by a project name and/or client name as shown in FIG. 3A. Associated with each project are client data, object or file data, options data and activity data. As shown in FIGS. 3B through 3E, the client data allows the user to enter information about the client including name, address, phone number, and Account ID associated with this particular project (FIG. 3B); object data contains a list of files or applications associated with the particular project (FIG. 3C); options data contains settings for threshold timers (FIG. 3D); and activity data shows the activity for each object, e.g. file or application, for this particular project (FIG. 3E).

When the desired file is opened, the filename of the file that is open will be checked with the database filenames, as shown in FIG. 3C, for recognition by the program (Step 206) and, upon confirmation, the time spent in the file is recorded in connection with the appropriate filename (Step 208), as shown in FIG. 3E. In the event that the program does not recognize the filename or a new file is to be worked on, an indication thereof, such as a dialog box, will be displayed on the computer monitor screen to alert the user that the filename is not among the set listed in the filename database and to query if the user wishes to track the time spent in the file (Step 210). The user may then enter the filename, if desired, and the dialog box is turned off in reaction to the filename entry into the database or by a keystroke or mouse click (Step 212). Additionally, the user may associate the newly created file with an existing client and/or project or may create a new client or project. Otherwise, the program will ignore this file and time will not be tracked for this particular file (Step 214).

Once a file to be tracked is opened, a clock of the operating system will track the time spent in the file using indications of continuing activity such as keystrokes, mouse clicks or cursor movements (Step 216). A clock icon may appear on the screen to advise the user that time is being tracked. The program will monitor the activity in the file until no activity is detected for a predetermined period of time (Steps 218 and 219). After expiration of a predetermined period of time, the time tracking will be stopped and the user will be prompted to determined if the user is finished with the file (Step 220). If the user indicates he is still working on the file, the program will go back to step 216 and continues to monitor activity in the file. Otherwise, the program will stop tracking time and forward the time tracking information to the database to generate a billing record (Step 222), as shown in FIG. 3E. The user may stop the clocking at any time or it may be stopped automatically upon the closing of the file being worked on (Step 224).

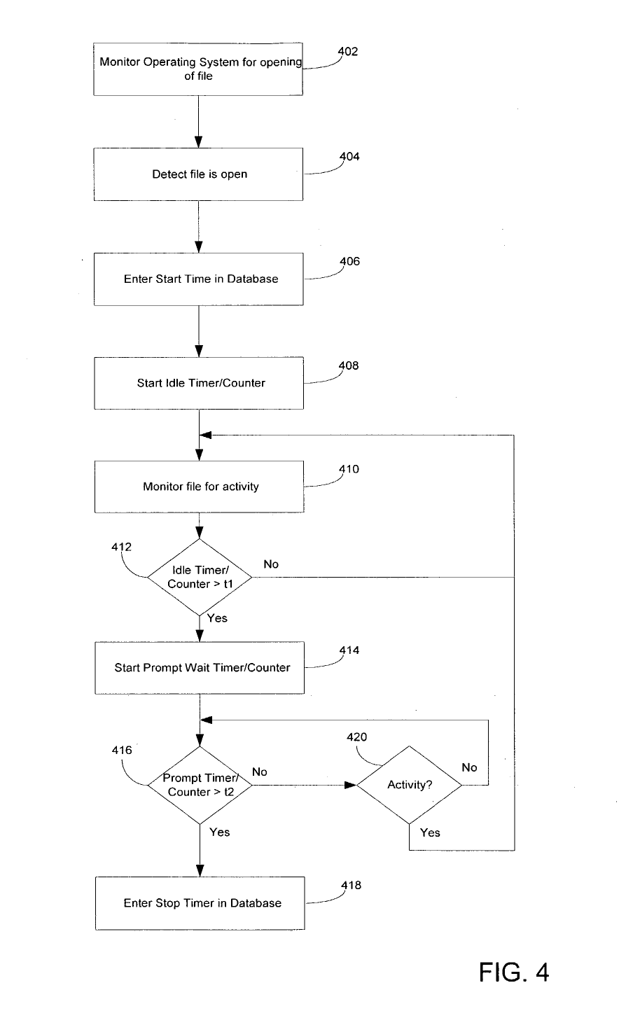

An operation of how the system and method calculates billable time in conjunction with a file will now be explained with reference to FIG. 4.

Once the timeclock program has been initiated, either through the boot process of the computer or manually started by the user, the program will monitor the operating system for opening and/closing of files (Step 402). The program will detect if a file is opened if a window handle or file handle is created (Step 404). As is known in the art, a file handle is a number that the operating system temporarily assigns to a file when it is opened and, similarly, a window handle is assigned to an opened window. If the file is already associated with a client project, a new billing record is created without further input from the user, a start time for the associated filename is entered in the database (Step 406) and an idle timer/counter is started (Step 408). If the file is new, the user will be prompted if the file is to be tracked as described above and, if it is to be tracked, a billing record will be created, a start time will be entered and the idle timer/counter will be started.

The program then monitors the file for any activity occurring in the file (Step 410). Activity will be detected by detecting interrupts caused by any known input device for affecting the file, such as a keyboard, mouse, joystick, digital pen, speech recognition device, etc. Every time activity is detected, the idle time/counter is reset to zero. If no activity is detected, the program determines whether the idle timer/counter has a value greater than a first predetermined time period t1 (Step 412). If the value of the idle timer counter is less than the first predetermined time period t1, the program will continue to monitor for user activity. If the value of the idle timer is greater than the first predetermined time period t1, an alert message box will be displayed to the user and a prompt wait timer/counter is started (Step 414). The alert message box will prompt the user if they want to continue billing the current client. The program will then determine if the prompt wait timer has a value greater than a second predetermined time period t2 (Step 416). If the value is less than t2, the program will determine if any new activity has occurred (Step 420). If activity has been detected, the program will go back to step 410, reset the value of the idle and prompt wait timer/counter to zero and continue tracking time for the file. If no activity has been detected, the program will continue to monitor the prompt wait timer/clock. If the value of the prompt wait timer/counter becomes greater than t2, a stop time for the associated filename is entered in the database (Step 418). After the stop time has been entered, the user will be prompted to start time tracking of the file again.

Alternatively, when the file is closed, the file handle is destroyed and a stop time for the associated filename will be entered in the database. The billable time for a file is derived from the start and stop times.

It is to be appreciate the above example provides for automatic time tracking of a file to be saved in a memory of the system 100. The method and system of the present invention will also track time spent on activities in which a file is not necessarily generated from the activity. For example, a browser may be opened for the user to conduct research on the Internet for a particular project. Since a particular file will not be created or modified, the program will monitor a window handle associated with the opening of the browser. When the program detects a window handle without a file handle, the program will prompt the user to associate the activity with the application, e.g., a browser, to a project. Similarly, the program of the present invention will track the writing and sending of e-mails.

The existence of the filename database also enables a user to jump from one file to another while working on the computer and count the time spent on each file. The program can be adapted to recognize which file is open and being worked in and to associate the time spent with each respective file for separately recording the time applied to each file. For example, a user begins work on a first file created in Adobe Illustrator and a billing record associated with the first file is created. While the first file is open, the user opens a second file to make some revisions. When the user begins work in the second file, an interrupt is detected in the second file indicating activity. At this time, a stop time is entered in the billing record of the first file and a start time is entered in a billing record of the second file. If the user clicks into the first file again, an interrupt will be generated in the first file indicating activity and a stop time will be entered in the billing record of the second file and a new billing record is created for the first file. Several billing records for each file can be later accumulated to generate a consolidated bill. In this manner, a user may jump around in several open files and/or applications and the program will recognize which file/application the user is in and how much time is spent in each.

The various times that are recorded by the program in association with each file can be accessed and read out on the computer display screen or on a printable report in itemized form. The program can collect all of the timing data developed during work on one or more files and present the data in different forms. Time spent on a particular file or set of files can be itemized on a daily, weekly, monthly, or annual basis. Time reports can be customized to present the information that a user needs or desires. For example, reports can itemize the name of the user who has worked in a file, the date and time a file was worked in and for how long.

The program may also be made available from a server for use by more than one user and on more than one computer so that information on the time spent on a file by different departments communicating on a network within an organization can be assembled and presented for billing purposes and for scheduling as to who will access a file and when they will work on a particular file. The program also can combine time spent on several separate files into a single bill. The bill can be itemized or aggregated in accordance with user instructions.

All of the users can obtain time reports.

The time records may be kept in the filename database or a clock database and made uneditable by the workers, when appropriate, by means of a lock in the clock database. In such event, an administrator would be the only one who can access and edit the filenames and the associated clock timings.

It will be seen that the present invention provides a system and method that may be used to advantage by various entities such as self-employed contractors and small businesses, as well as larger firms with cooperating departments and particularly publishing companies, advertising agencies, design studios, law firms, and other enterprises wherein it is necessary or appropriate for someone to track the time spent working on a computer or like device for cost determining or billing purposes.

While the invention has been shown and described with reference to certain preferred embodiments thereof, it will be understood by those skilled in the art that various changes in form and detailed may be made therein without departing from the spirit and scope of the invention as defined by the appended claims.

What is claimed is:

1. A method for tracking time spent working on each file in a set of computer files, the method comprising the steps of:
detecting an opening of at least one file;
recording a start time of the opening of the at least one file;
monitoring the at least one opened file for user activity;
if no user activity is detected, recording a stop time for the at least one opened file; and
determining the time spent working on the at least one file from the start time and stop time.

2. The method of claim 1, further comprising the steps of:
detecting openings of a plurality of files;
recording a start time of a first file wherein activity is detected; and
upon detecting activity in a second file, recording a stop time for the first file and recording a start time for the second file.

3. The method of claim 1, further comprising the steps of:
determining if a filename of the at least one opened file is listed in a database, and if the filename is not in the database, prompting the user to add the filename to the database.

4. The method of claim 3, wherein if the user does not add the filename to the database, ignoring the start time and stop time for the file.

5. The method of claim 1, wherein the detecting an opening step includes detecting a creation of a file handle upon the opening of a file.

6. The method of claim 1, wherein the monitoring step monitors the at least one opened file for interrupts generated indicative of user activity.

7. The method of claim 1, further comprising the steps of:
upon detection of the opening of at least one file, starting an idle timer; and
resetting the idle timer to zero whenever activity is detected, wherein if the idle timer exceeds a first predetermined time period, recording the stop time for the at least one open file.

8. The method of claim 1, further comprising the steps of:
upon detection of the opening of at least one file, starting an idle timer;
resetting the idle timer to zero whenever activity is detected;
if the idle timer exceeds a first predetermined time period, prompting the user to continue monitoring the at least one opened file; and
starting a prompt wait timer, wherein if the user does not acknowledge the prompt wait timer after a second predetermined time period, recording the stop time for the at least one file.

9. The method of claim 1, further comprising the step of recording the stop time for the at least one opened file upon the file being closed.

10. The method of claim 9, wherein the closing of the at least one file is determined by detecting destruction of an associated file handle.

11. The method of claim 1, further comprising the steps of:
detecting an opening of at least one application program;
recording a start time of the opening of the at least one application program;
monitoring the at least one opened application program for user activity;
if no user activity is detected, recording a stop time for the at least one opened application program; and
determining the time spent working on the at least one application program from the start time and stop time.

12. A program storage device readable by a machine, tangibly embodying a program of instructions executable by the machine to perform method steps for tracking time spent working on each file in a set of computer files, the method steps comprising:
detecting an opening of at least one file;
recording a start time of the opening of the at least one file;
monitoring the at least one opened file for user activity;
if no user activity is detected, recording a stop time for the at least one opened file; and
determining the time spent working on the at least one file from the start time and stop time.

13. The program storage device of claim 12, further comprising the steps of:
detecting openings of a plurality of files;
recording a start time of a first file wherein activity is detected; and
upon detecting activity in a second file, recording a stop time for the first file and recording a start time for the second file.

14. The program storage device of claim 12, further comprising the steps of:
determining if a filename of the at least one opened file is listed in a database, and if the filename is not in the database, prompting the user to add the filename to the database.

15. The program storage device of claim 14, wherein if the user does not add the filename to the database, ignoring the start time and stop time for the file.

16. The program storage device of claim 12, wherein the detecting an opening step includes detecting a creation of a file handle upon the opening of a file.

17. The program storage device of claim 12, wherein the monitoring step monitors the at least one opened file for interrupts generated indicative of user activity.

18. The program storage device of claim 12, further comprising the steps of:
upon detection of the opening of at least one file, starting an idle timer; and
resetting the idle timer to zero whenever activity is detected, wherein if the idle timer exceeds a first predetermined time period, recording the stop time for the at least one open file.

19. The program storage device of claim 12, further comprising the steps of:
upon detection of the opening of at least one file, starting an idle timer;
resetting the idle timer to zero whenever activity is detected;
if the idle timer exceeds a first predetermined time period, prompting the user to continue monitoring the at least one opened file; and
starting a prompt wait timer, wherein if the user does not acknowledge the prompt wait timer after a second predetermined time period, recording the stop time for the at least one file.

20. The program storage device of claim 12, further comprising the step of recording the stop time for the at least one opened file upon the file being closed.

21. The program storage device of claim 20, wherein the closing of the at least one file is determined by detecting destruction of an associated file handle.

22. The program storage device of claim 12, further comprising the steps of:
detecting an opening of at least one application program;
recording a start time of the opening of the at least one application program;
monitoring the at least one opened application program for user activity;
if no user activity is detected, recording a stop time for the at least one opened application program; and
determining the time spent working on the at least one application program from the start time and stop time.

23. A system for tracking time spent working on each file in a set of computer files, the system comprising:
means for detecting an opening of at least one file;
means for recording a start time of the opening of the at least one file;
means for monitoring the at least one opened file for user activity;
if no user activity is detected, recording a stop time for the at least one opened file; and
means for determining the time spent working on the at least one file from the start time and stop time.

24. The system of claim 23, further comprising:
means for detecting openings of a plurality of files;
means for recording a start time of a first file wherein activity is detected; and
upon detecting activity in a second file, means for recording a stop time for the first file and recording a start time for the second file.

25. The system of claim 24, further comprising a memory for storing at least one file and its associated start time, stop time, and total time spent working on the at least one file.

26. The system of claim 23, further comprising a clock for providing time and date of the recorded start time and stop time.

27. The system of claim 23, further comprising an interrupt detector for detecting interrupts indicative of user activity.

28. The system of claim 23, further comprising a handle detector for detecting file handles indicative of an opening of a file.

29. The system of claim 23, further comprising an idle timer for determining a time to record the stop time after a period of user inactivity.
